(19) United States
(12) Patent Application Publication
(10) Pub. No.: US 2026/0359344 A1
(43) Pub. Date: Nov. 12, 2026

(54) METHOD, DEVICE, AND STORAGE MEDIUM FOR QUESTION ANSWERING PROCESSING

(71) Applicant: Beijing Zitiao Network Technology Co., Ltd., Beijing (CN)

(72) Inventor: Mingkun MO, Beijing (CN)

(21) Appl. No.: 19/668,541

(22) Filed: May 5, 2026

(30) Foreign Application Priority Data
May 9, 2025 (CN) 202510601090.8

(51) Int. Cl. G06F 16/435; G06F 16/41

(52) U.S. Cl. CPC G06F 16/435; G06F 16/41

(57) ABSTRACT

The present disclosure provides a solution for question answering processing. A method includes: extracting, in response to receiving a query request from a user, keyword information from the query request; determining, based on a match between the keyword information and keyword information corresponding to an image in a dataset associated with the user, at least one image matching the keyword information from the dataset, the dataset including images received during a historical interaction with the user and corresponding keyword information; and determining, using a machine learning model, a reply to the query request based at least on the query request and the at least one image.

### CROSS-REFERENCE TO RELATED APPLICATION

This application claims priority to Chinese Patent Application No. 202510601090.8, filed on May. 09, 2025, and entitled “METHOD, APPARATUS, DEVICE, STORAGE MEDIUM AND PROGRAM PRODUCT FOR QUESTION ANSWERING PROCESSING”, which is incorporated herein by reference in its entirety.

### TECHNICAL FIELD

Example embodiments of the present disclosure generally relate to the field of computers, and in particular, to question answering processing.

### BACKGROUND

With the development of information technology, various terminal devices may provide people with various services in work and life. For example, an application that provides a service may be deployed in the terminal device. The terminal device or the application may provide a user with a digital assistant-like function to assist the user in using the terminal device or the application. The user may complete diverse operations through various interactions with the digital assistant.

### SUMMARY

In a first aspect of the present disclosure, a method for question answering processing is provided. The method includes: extracting, in response to receiving a query request from a user, keyword information from the query request; determining, based on a match between the keyword information and keyword information corresponding to an image in a dataset associated with the user, at least one image matching the keyword information from the dataset, the dataset including images received during a historical interaction with the user and corresponding keyword information; and determining, using a machine learning model, a reply to the query request based at least on the query request and the at least one image.

In a second aspect of the present disclosure, an electronic device is provided. The electronic device includes: at least one processing unit; and at least one memory, which is coupled to the at least one processing unit and stores instructions executable by the at least one processing unit, the instructions, when executed by the at least one processing unit, causing the electronic device to perform the method of the first aspect.

In a third aspect of the present disclosure, a computer-readable storage medium is provided. The computer-readable storage medium includes a computer program stored thereon, the computer program, when executed by a processor, causing the processor to perform the method of the first aspect.

In a fourth aspect of the present disclosure, a computer program product is provided. The computer program product is tangibly stored in a computer storage medium and includes computer-executable instructions, the computer-executable instructions, when executed by a device, causing the device to perform the method of the first aspect.

It should be understood that content described in this summary is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 is a schematic diagram of an example environment in which the embodiments of the present disclosure may be implemented;

FIG. 2 shows an example architecture for question answering processing according to some embodiments of the present disclosure;

FIG. 3 shows an example architecture for dataset updating according to some embodiments of the present disclosure;

FIG. 4 shows a flowchart of a method for question answering processing according to some embodiments of the present disclosure;

FIG. 5 shows an exemplary structural block diagram of an apparatus for question answering processing according to some embodiments of the present disclosure; and

FIG. 6 shows a block diagram of an electronic device in which one or more embodiments of the present disclosure may be implemented.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only used for illustrative purposes and are not used to limit the protection scope of the present disclosure.

In the description of the embodiments of the present disclosure, the term "include/comprise" and similar terms thereof should be understood as open-ended inclusions, that is, "include/comprise but not limited to". The term "based on" should be understood as "at least partially based on". The term "an embodiment" or "the embodiment" should be understood as "at least one embodiment". The term "some embodiments" should be understood as "at least some embodiments". Other explicit and implicit definitions may be included below.

In this specification, unless explicitly stated, "in response to A" performing a step does not mean that the step is performed immediately after "A", but may include one or more intermediate steps.

It may be understood that the data involved in the technical solution (including but not limited to the data itself, obtaining, use, storage, or deletion of the data) should comply with requirements of corresponding laws, regulations, and related provisions.

It may be understood that before the use of the technical solutions disclosed in the embodiments of the present disclosure, the user should be informed of the type, range of use, use scenarios, etc., of personal information involved in the present disclosure, and the authorization of the user should be obtained in an appropriate manner in accordance with relevant laws and regulations.

For example, in response to receiving an active request from the user, prompt information is sent to the user to clearly prompt the user the personal information that is required to be obtained and used by the requested operation, so that the user may independently choose, based on the prompt information, whether to provide the personal information to the software or hardware, such as the electronic device, the application, the server, or the storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text manner. In addition, the pop-up window may also include a selection control for the user to select whether to "agree" or "disagree" to provide the personal information to the electronic device.

It may be understood that the above process of notifying and obtaining the authorization of the user is only illustrative, and does not intend to limit the implementations of the present disclosure, other manners that satisfy the relevant laws and regulations may also be applied in the implementations of the present disclosure.

As used herein, the term "model" may learn a correlation between corresponding inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, the "model" may also be referred to as a "machine learning model", a "learning model", a "machine learning network", or a "learning network", which are used interchangeably herein.

Generally, machine learning may be roughly divided into three stages, namely, a training stage, a testing stage, and an application stage (also referred to as an inference stage). In the training stage, a given model may be trained using a large amount of training data, and a parameter value may be updated through continuous iteration until the model may obtain, from the training data, consistent inference that satisfies an expected objective The model may be considered to be able to learn a correlation . T from an input to an output (also referred to as a mapping from the input to the output) from the training data through training. The parameter value of the trained model may be determined. In the testing stage, a test input is applied to the trained model to test whether the model may provide a correct output, thereby determining the performance of the model. The testing stage may sometimes be incorporated into the training stage. In the application stage or inference stage, the trained model may be used to process an actual model input based on the parameter value obtained based on training and determine a corresponding model output.

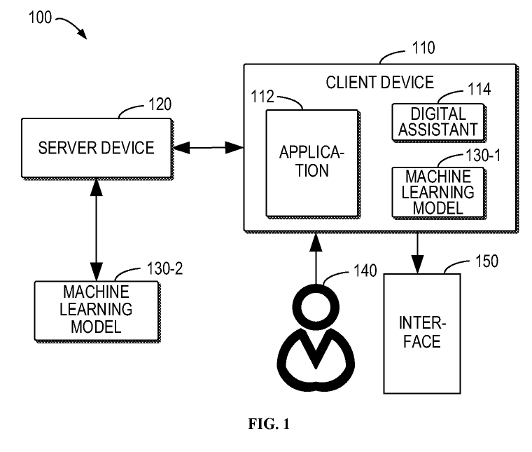

FIG. 1 is a schematic diagram of an example environment 100 in which the embodiments of the present disclosure may be implemented. In the example environment 100, an application 112 and a digital assistant 114 may be installed in a client device 110. A user 140 may interact with the application 112 via the client device 110 and/or an attachment device of the client device 110. In some implementations, the application 112 may be authorized to collect speech via an audio collecting device (such as a microphone) of the client device 110, collect an image via an image collecting device (such as a camera) of the client device 110, etc.

In some embodiments, the application 112 and the digital assistant 114 may be downloaded and installed on the client device 110. In some embodiments, the application 112 and the digital assistant 114 may also be accessed in other manners, such as web page access.

In the embodiments of the present disclosure, the application 112 may be any appropriate application having an answering function, which may include but is not limited to one or more of the following: a chat application component (also referred to as an instant messaging application component), a browser application component, a planning application component, a document application component, an audio and video conference application component, an email application component, a task application component, a calendar application component, an objective and key result (OKR) application component, etc. It may be understood that although a single application is shown in FIG. 1, multiple applications may actually be installed on the client device 110. In some embodiments, the application 112 may include a multi-functional collaboration platform, for example, an office collaboration platform (also referred to as an office suite) may provide an integration of multiple types of business components to facilitate activities such as office work and communication for people. In the multi-functional collaboration platform, people may start different business components as needed to complete corresponding information processing, sharing, communicating, etc.

In some embodiments, the digital assistant 114 may be provided by a separate application or may be integrated in the application 112 that may provide content entities. The application service component for providing the client interface of the digital assistant may correspond to a single-function application service component or a multi-functional collaboration platform, such as an office suite or other collaboration platforms that may integrate multiple components. It may be understood that, similar to the application, although a single digital assistant is shown in FIG. 1, there may actually be multiple digital assistants.

In some embodiments, the digital assistant 114 supports the use of plugins. Each plugin may provide one or more functions of the application. Such plugins include but are not limited to one or more of the following: a search plugin, a contact plugin, a message plugin, a document plugin, a table plugin, an email plugin, a calendar plugin, a schedule plugin, a task plugin, etc.

The digital assistant 114 is an intelligent assistant of the user, having intelligent conversation and information processing capabilities. In the embodiments of the present disclosure, the digital assistant 114 is configured to interact with the user 140 to assist the user 140 in using the client device 110 or the application 112. In some embodiments, multiple interaction modes between the user 140 and the digital assistant 114 may be provided, and flexible switching between the multiple interaction modes may be possible. In the case where a certain interaction mode is triggered, a corresponding interaction region is presented to facilitate the interaction between the user 140 and the digital assistant 114. The interaction manners between the user 140 and the digital assistant 114 in different interaction modes are different, so that may be flexibly adapted to the interaction requirements in different application scenarios.

In the environment 100 the client device 110 may present, in response to the application 112 being launched, an interface 150 of the application 112 and/or the digital assistant 114. The interface 150 may include, for example, an interaction interface of the application 112 and the digital assistant 114. In some embodiments, an interaction window between the user 140 and the digital assistant 114 may be presented in the interface 150. In the interaction window, the user 140 may have a talk with the digital assistant 114 by inputting a natural language, a picture, an audio file, a video file, a web page file, etc., to instruct the digital assistant to assist in completing various tasks.

The interaction window between the digital assistant 114 and the user 140 may include a chat window, such as a chat window in an instant messaging application or an instant messaging module of a specific application. In the chat window, the interaction between the digital assistant 114 and the user 140 may be presented in the form of chat messages. Alternatively or additionally, the interaction window between the digital assistant 114 and the user 140 may further include other types of windows, such as a window in a floating window mode, in which the user 140 may trigger the digital assistant 114 to perform corresponding operations by inputting instructions, selecting quick instructions, etc.

In some embodiments, the digital assistant 114 may support an interaction mode of the chat window, which may also be referred to as a conversation mode. In this interaction mode, a chat window between the user 140 and the digital assistant 114 is presented, in which the user 140 and the digital assistant 114 interact through chat messages. In the conversation mode, the digital assistant 114 may perform tasks according to the chat messages in the chat window. In the interaction window, the user 140 inputs an interaction message, and the digital assistant 114 provides a reply message in response to the user input. The chat window with the digital assistant 114 may be opened by selecting the digital assistant 114. The chat window may include interface elements for information interaction, such as an input box, a message list, a message bubble, etc.

The reply function of the application 112 may be supported based on an output of a machine learning model. The machine learning model may be a machine learning model 130-1 deployed locally on the client device 110, or may be a machine learning model 130-2 deployed on the server device 120. That is, the client device 110 may directly invoke the local machine learning model 130-1 to support the reply function of the application 112 based on the output of the local machine learning model 130-1. The server device 120 may provide a backend service for the application 112, which may invoke the machine learning model 130-2 to support the reply function of the application 112 based on the output of the machine learning model 130-2. The machine learning model 130-1 and the machine learning model 130-2 may be collectively referred to as a machine learning model 130.

The machine learning model 130 may be based on any appropriate model structure, including but not limited to a Transformer model, a convolutional neural network (CNN), a recurrent neural network (RNN), a deep neural network (DNN), etc. In some embodiments, the machine learning model 130 may be based on a language model (LM). The language model may acquire question answering capabilities by learning from a large amount of corpus. The machine learning model 130 may also be based on other appropriate models. The machine learning model 130 may include one or more machine learning models. It should be noted that if the machine learning model 130 includes multiple machine learning models, the multiple machine learning models may have different structures, uses, and functions, which is not limited in the present disclosure.

In some embodiments, a communication connection is established between the client device 110 and the server device 120. The communication connection may be established in a wired or wireless manner. The communication connection may include but is not limited to a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the client device 110 and the server device 120 may implement signaling interaction through the communication connection therebetween, so as to implement the provision of the services of the application 112 and/or the digital assistant 114.

The client device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices or any combination thereof. In some embodiments, the client device 110 may also support any type of user-specific interface (such as a "wearable" circuit, etc.).

The server device 120 may be an independent physical server, and may also be a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device 120 may include, for example, a computing system/server, such as a mainframe, an edge computing node, a computing device in a cloud environment, etc.

It should be understood that the structure and functions of the elements in the environment 100 are described for illustrative purposes only, without suggesting any limitation on the scope of the present disclosure.

As mentioned above, the user may complete diverse operations through various interactions with the digital assistant. The user may provide user input of at least one modality to the digital assistant, for example, the user may provide speech and image to the digital assistant. The digital assistant may then determine a reply to the image based on the received speech and image. Conventionally, the reply may usually only be determined based on the image received in real time, and the reply cannot be determined in combination with the image collected historically or may only be determined in combination with the historical image in a relatively short period of time (for example, within the past hour), which may affect the accuracy of the reply and the reply experience of the user.

The reason why the historical image cannot be relied on or only the historical image in a relatively short period of time may be relied on is that a machine learning model is usually used to determine the reply. The model input of the machine learning model is usually limited. Due to the large amount of input data (the number of input tokens) occupied by the image data, the model input may only include a certain number of images and cannot be filtered in combination with all historical images. In addition, conventionally, the proximity principle is usually adopted, considering combining the latest historical images (for example, images involved in the interaction in the past one hour), but these images may be irrelevant to the question of the user this time (for example, the question of the user this time may involve images from yesterday or earlier, rather than images from a few minutes ago), which may affect the accuracy of the reply.

In view of this, according to the embodiments of the present disclosure, an improved solution for question answering processing is provided. According to the solution of the embodiments of the present disclosure, keyword information is extracted from a query request in response to receiving the query request from the user. Based on a match between the keyword information and keyword information corresponding to the images in a dataset associated with the user, at least one image matching the keyword information is determined from the dataset. The dataset includes images received during a historical interaction with the user and corresponding keyword information. A reply to the query request is determined using a machine learning model based at least on the query request and the at least one image.

In this way, the image most relevant to or matching the query request received this time may be retrieved from a large number of images involved in historical interactions, and the reply to the query request may be determined based on the obtained image. Through separate information storage, key information extraction, and retrieval, the solution proposed in the present disclosure may overcome the limitation on input of the model and retrieve limited and relevant images for processing the query request this time. This may be helpful to improve the accuracy of the reply and improve the user with a reply interaction experience during the reply process.

Some example embodiments of the present disclosure will be further described below with reference to the drawings. The question answering processing method involved in the present disclosure may be implemented on the client device 110. It should be noted that the operations performed by the client device 110 may be specifically performed by a related application (such as the application 112) and/or a digital assistant (such as the digital assistant 114) installed on the client device 110. Some operations described with reference to the client device 110 may require the assistance of the server device 120 to complete.

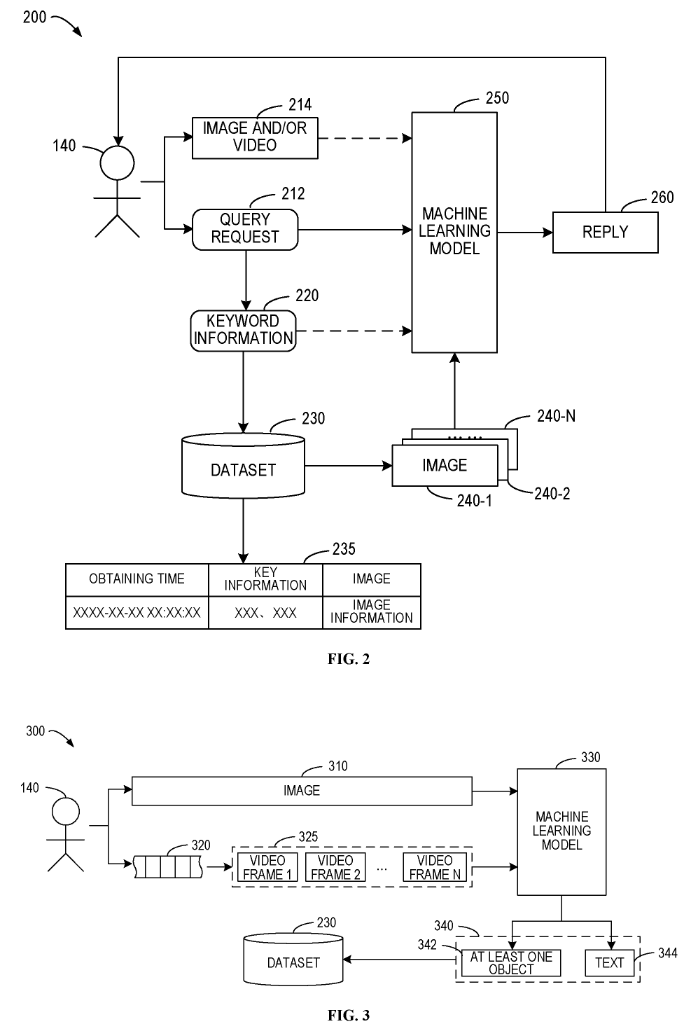

FIG. 2 shows an example architecture 200 of question answering processing according to some embodiments of the present disclosure. The example architecture 200 may be implemented at the client device 110. As shown in FIG. 2, the client device 110 may receive a query request 212 from a user 140. As an example, the client device 110 may receive, during an interaction process between the user 140 and the digital assistant (such as the digital assistant 114), the query request 212 for the digital assistant 114 sent by the user 140. As an example, the interaction may include chat interaction via the user interface, speech interaction via a speaker/microphone, etc. The client device 110 may receive the query request 212 in any appropriate manner. For example, the client device 110 may receive a query request 212 in speech that is input by the user 140 via a microphone, receive a query request 212 in text that is input by the user 140 via an input box, receive a gesture-type query request 212 via a camera, etc. The present disclosure does not limit the specific manner of receiving the query request 212.

The client device 110 may extract, in response to receiving the query request 212, keyword information 220 from the query request 212. In some embodiments, if the query request 212 is a text-type query request, the query request may be referred to as query text. The client device 110 may directly extract the keyword information 220 from the query text. If the query request 212 is a non-text-type query request (for example, a query request in speech, and such a query request may also be referred to as query speech), the client device 110 may convert the non-text-type query request into query text (for example, by using a speech recognition (ASR) model), and then extract the keyword information 220 from the query text.

The client device 110 may extract the keyword information 220 from the query text in any appropriate manner. In some embodiments, the client device 110 may extract the keyword information 220 from the query text corresponding to the query request 212 through keyword division processing. The keyword division processing may include multiple processing techniques, and as an example only, it may include a natural language processing (NLP) sentence segmentation technique, an NLP keyword segmentation technique, etc. In some embodiments, the client device 110 may further use a trained machine learning model to extract the keyword information 220 from the query text. The machine learning model may be, for example, one of the machine learning models 130, which may be based on any appropriate model structure, and as an example only, it may be a language model. The present disclosure does not limit the specific keyword extraction method.

The client device 110 may determine, based on a match between the keyword information 220 and keyword information corresponding to an image in a dataset 230 associated with the user 140, at least one image matching the keyword information 220 from the dataset 230. The dataset 230 may be deployed locally on the client device 110 or on other devices (for example, on the server device 120). The dataset 230 may include a database, a data storage system or device, etc.

The dataset 230 includes images received during a historical interaction with the user 140 and corresponding keyword information. In some embodiments, the dataset 230 further includes an obtaining time, an obtaining location, an obtaining environment and so on, corresponding to each image. Table 235 in FIG. 2 shows an example of a piece of data stored in the dataset, and the piece of data may include an obtaining time corresponding to an image, keyword information corresponding to the image, and image information of the image (the image information may be the image). The historical interaction process with the user 140 may be, for example, a historical interaction process between the user 140 and the digital assistant 114. The images received during the historical interaction with the user 140 may include images collected during the historical interaction, and may also include video frames extracted from videos collected during the historical interaction.

In the embodiments of the present disclosure, it is proposed to store historically received images, key information of those images, and obtaining times in the separate dataset 230. These data may be stored for a long time for subsequent use. It may be understood that the data obtaining and storage in the dataset 230 are known and authorized by the user. In some embodiments, the dataset 230 may be stored in a database or any other appropriate storage system. The dataset 230 may be stored locally on the client device 110 or in a storage system accessible by the client device 110.

In some embodiments, the dataset 230 may further include images that are stored in the dataset 230 after being authorized by the user, which are not received during the historical interaction process with the user. These images may include, for example, images collected by the user using an image collector of the client device 110, or images acquired by the user through screenshots, downloads and saves, etc. These images are stored in the dataset 230 after being authorized by the user. It may be understood that the storage manner of these images is similar to that of the images received during the historical interaction process, and the dataset 230 may also include key information, obtaining time/storage time, etc., of these images.

The client device 110 may determine a matching degree between the keyword information 220 and the keyword information corresponding to each image in the dataset 230. The client device 110 may determine the matching degree in any appropriate manner. As an example, the client device 110 may determine, in response to the obtaining time corresponding to a certain image and text included in the keyword information being the same as text included in the keyword information 220, the matching degree between a certain image and the keyword information 220 is high. The client device 110 may determine, in response to the semantics of the keyword information corresponding to a certain image being the same as the semantics of the keyword information 220, the matching degree between a certain image and the keyword information 220 is relatively high. The client device 110 may determine the matching degree between the keyword information corresponding to each image and the keyword information 220, for example, by using a trained machine learning model. The machine learning model may be, for example, one of the machine learning models 130, which may be based on any appropriate model structure, and only as an example, it may be a language model. The present disclosure does not limit the specific determining manner of the matching degree.

As an example only, if the query text corresponding to the query request is "What is the price of the coat I saw in the XX store yesterday", the client device 110 may determine that the keyword information 220 corresponding to the query text includes "XX store", "coat", and "yesterday". If an image A stored in the dataset 230 is collected and stored in the dataset 230 during a user question answering interaction yesterday, and the keyword information of the image A is "XX store" and "coat", the client device 110 may then determine that the image A matches the query text.

The client device 110 may determine, for example, in response to the matching degree between the keyword information of a certain image in the dataset 230 and the keyword information 220 being higher than a threshold, that keyword information corresponding to the image matches the keyword information 220. The client device 110 may determine at least one image 240 (which may include an image 240-1, an image 240-2, ..., and an image 240-N, where N is a positive integer, and one or more images may be collectively referred to as an image 240) from the dataset 230, the keyword information corresponding to which matches the keyword information 220.

The client device 110 may determine, based at least on the query request 212 and the at least one image 240, a reply 260 to the query request 212 using a machine learning model 250. The machine learning model 250 may be, for example, one of the machine learning models 130, which may be based on any appropriate model structure. In some embodiments, the machine learning model 250 may be constructed based on a language model. As an example, in some embodiments, the client device 110 may further use the machine learning model 250 to determine the reply 260 to the query request 212 based on the query request 212, the keyword information 220, and the at least one image 240.

In some embodiments, the client device 110 may further receive an image and/or a video 214 (the image therein may be referred to as a first image, and the video therein may be referred to as a first video) in association with the reception of the query request 212. That is, the client device 110 may receive at least one of an image or a video while receiving the query request 212 during the interaction process between the user 140 and the digital assistant 114. The image and/or the video 214 may be collected in real time by the client device 110 via an image collecting component. In some embodiments, the image and/or the video 214 may also be pre-stored in the client device 110, and the client device 110 may directly receive the local image and/or video 214 in response to receiving a selection of the user 140 for the image and/or video 214 stored locally during the interaction.

In this case, if the image and/or the video 214 include a video (that is, the client device 110 receives at least the query request 212 and the video at the same time), the client device 110 may extract multiple video frames from the received video. The multiple video frames may be extracted randomly from the video, or may be extracted based on a predetermined interval. For example, the client device 110 may extract one video frame from the received video every 0.1 second. The client device 110, for example, may use the machine learning model 250 to determine the reply 260 to the query request 212 based on the query request 212, the at least one image 240, and also on the received first image and/or the video frames extracted from the first video. A single video frame extracted from the video may also be regarded as a single image.

The client device 110 may determine a model input for the machine learning model 250, for example, based on the query request 212, the at least one image 240, and further based on the received first image and/or the video frames extracted from the first video. In some embodiments, the client device 110 may acquire a prompt template for the machine learning model 250, and acquire a prompt input for the machine learning model 250 by filling the query request 212, the at least one image 240, and further based on the received first image and/or the video frames extracted from the first video into the prompt template. The client device 110 may provide the model input/prompt input to the machine learning model 250, and acquire a model output that output by the machine learning model 250. The client device 110 may determine the reply 260 based on the model output.

In some embodiments, the model input of the machine learning model 250 is defined to include at most a predetermined number of images. The predetermined number may be any appropriate number. The reason for the number limitation is that the input of the machine learning model 250 has an upper limit requirement, and the upper limit requirement may be for the image data itself, or for the image data and other modality data (including the query text corresponding to the query request). In this case, the sum of the number of the received first image and/or the extracted video frames plus the number of the at least one image 240 is less than or equal to the predetermined number. That is, the total number of images retrieved from the dataset 230 and the image/video frames acquired in the query request this time does not exceed the model input limitation of the machine learning model 250. Here, each video frame may be considered as an image.

As an example, taking the case where a video is received synchronously with the query request 212 as an example, if the model input includes at most 10 images, the sum of the number of the at least one image 240 retrieved from the dataset 230 plus the number of video frames extracted from the video needs to be less than or equal to 10. Therefore, an image related to the query request this time is retrieved from a large number of pre-stored historical images, and the reply is determined using such an image, instead of inputting all the historical images into the model and the model selecting the most relevant image from the large number of images. This may reduce the computation load of the model and help improve the reply efficiency.

In some embodiments, in order to ensure the real-time performance and accuracy of the reply 260, in the case where the image and/or the video 214 are received synchronously with the query request 212, it may be limited that the model input should include both the at least one image 240 retrieved from the dataset 230, and the first image and/or the video frames extracted from the first video. In some embodiments, it may be limited that the number of the images 240 cannot exceed a first number. In this case, if the number of the images 240 does not exceed the first number (that is, less than or equal to the first number), the client device 110 may determine a first group of images and/or a first group of video frames from the received first image and/or video frames according to a reception time. The sum of the number of the determined first group of images and/or the first group of video frames is a second number, and the sum of the second number and the first number is less than or equal to the predetermined number. The client device 110 may further use the machine learning model 250 to determine the reply 260 to the query request 212 based on the query request 212, the images 240, and also on the first group of images and/or the first group of video frames.

As an example, it is assumed that the predetermined number is 10, and it is predetermined that at most 5 images may be acquired from the dataset 230. In the case where the number of the images 240 retrieved from the dataset 230 is less than or equal to 5 (for example, the number of the images 240 is 2), the client device 110 may determine that the second number is less than or equal to 8 (that is, 10-2=8). If the image and/or the video 214 include only a video (that is, include only the first video), the client device 110 may determine, as the first group of video frames, the second number of video frames (the second number should be less than or equal to 8, that is, the second number is at most 8) that correspond to the extraction time closest to the current moment from all the video frames extracted from the first video. The client device 110 may further determine, using the machine learning model 250, the reply 260 to the query request 212 based on the query request 212, the images 240 (including 2 images), and the first group of video frames (for example, including 8 video frames).

If the number of the images 240 exceeds the first number, the client device 110 may determine, from the images 240, the first number of images based on the matching degree between the keyword information 220 and the keyword information corresponding to the images 240, respectively. The client device 110 may determine the matching degree in any appropriate manner. For example, the client device 110 may sort the images 240 in a descending order of the corresponding matching degree, and then determine a group of first images from the sorting result.

The client device 110 may further determine a second group of images and/or a second group of video frames from the first image and/or the extracted video frames according to the reception time. The sum of the image number in the second group of images and/or the image number in the second group of video frames is a third number, and the sum of the third number and the first number is less than or equal to the predetermined number. The client device 110 may further use the machine learning model 250 to determine the reply 260 to the query request based on the query request 212 and the first number of images, and further based on the second group of images and/or the second group of video frames.

As an example, taking the case where the predetermined number is 10, and it is predetermined that at most 5 images may be acquired from the dataset 230 in advance (that is, the first number is 5) as an example, if the images 240 include 8 images and the first number is 5, then the client device 110 may determine, from the images 240, 5 images with the highest corresponding matching degree. The client device 110 may determine that the sum of the image number in the second group of images and/or the image number in the second group of video frames is less than or equal to 10-5=5. If the image and/or the video 214 include only the video (that is, include only the first video), the client device 110 may determine, as the second group of video frames, the third number of video frames (the third number should be less than or equal to 5, that is, the second number is at most 5) that are closest to the current moment in terms of extraction time from all the video frames extracted from the first video. The client device 110 may further use the machine learning model 250 to determine the reply 260 to the query request 212 based on the query request 212, the images 240 (including 5 images), and the second group of video frames (for example, including 5 video frames).

The specific manner of acquiring an image associated with the query request 212 from the dataset 230 and determining the answer 260 based on the acquired image is described above, and the specific manner of updating the dataset 230 is described below with reference to FIG. 3. FIG. 3 shows an example architecture 300 of dataset updating according to some embodiments of the present disclosure. The example architecture 300 may be implemented at the client device 110.

In each interaction process with the user, the client device 110 may receive an image 310 and/or a video 320. The image 310 and/or the video 320 may be collected by the client device 110 in real time via an image collecting component during the interaction process, or may be pre-stored locally and acquired by the client device 110 in response to a user selection. In the case of receiving the video 320, the client device 110 may extract a plurality of video frames 325 from the video 320. The plurality of video frames 325 may be extracted randomly from the video 320, or may be extracted from the video 320 at a predetermined interval.

The client device 110 may extract keyword information 340 from the image 310 and/or the video frames 325. For example, the client device 110 may perform object recognition processing on the image 310 and/or the video frames 325 to determine at least one object 342, and determine an object identification (for example, any appropriate identification such as an object name, an object ID, and object description information) of the at least one object 342 as at least a part of the keyword information 340. For example, the client device 110 may further perform text recognition processing on the image 310 and/or the video frames 325 to determine text 344, and determine the text 344 as at least a part of the keyword information 340. In the dataset 230, the video frame extracted from the video may be regarded as an image.

For example, the client device 110 may use a trained machine learning model 330 to perform the object recognition processing and/or the text recognition processing. The machine learning model 330 may be, for example, any machine learning model of the machine learning models 130, and the machine learning model 330 may include one or more machine learning models. For example, the machine learning model 330 may include one machine learning model for performing the object recognition processing and one machine learning model for performing the text recognition processing. The client device 110 may store the extracted keyword information 340, the image 310 and/or the video frames 325, and the reception time of the image 310 or the extraction time of the video frames 325 in the dataset 230 in an association way.

Therefore, when constructing or updating the dataset, the key information of the image may be extracted from the image for matching with the keyword information in the query request, which helps to quickly retrieve the relevant image every time and improves the reply efficiency.

In summary, according to the embodiments of the present disclosure, an image most relevant to or matching the query request received this time may be retrieved from a large number of images involved in historical interactions, and an answer to the query request may be determined based on the obtained image. Through separate information storage, key information extraction, and retrieval, the solution proposed in the present disclosure may break the input limitation of the model and retrieve limited and relevant images for processing the query request this time. This helps to improve the accuracy of the answer and provide the user with a reply interaction experience during the reply process.

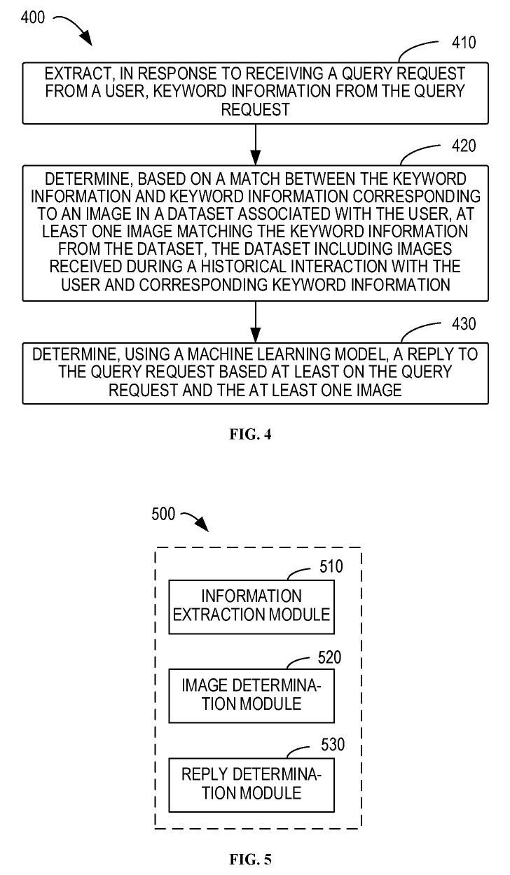

FIG. 4 shows a flowchart of a method 400 for question answering processing according to some embodiments of the present disclosure. The method 400 may be implemented at the client device 110 in FIG. 1. The method 400 will be described with reference to the environment 100 in FIG. 1.

At block 410, the client device 110 extracts, in response to receiving a query request from a user, keyword information from the query request.

At block 420, the client device 110 determines, based on a match between the keyword information and keyword information corresponding to an image in a dataset associated with the user, at least one image matching the keyword information from the dataset, the dataset including images received during a historical interaction with the user and corresponding keyword information.

At block 430, the client device 110 determines, using a machine learning model, a reply to the query request based at least on the query request and the at least one image.

In some embodiments, at least one of a first image or a first video is received in association with the reception of the query request, and determining the reply to the query request based at least on the query request and the at least one image includes: determining, using the machine learning model, the reply to the query request based on the query request, the at least one image, and further based on at least one of the received first image or video frames extracted from the first video.

In some embodiments, a model input of the machine learning model is defined to include at most a predetermined number of images, and a sum of the received first image and/or the extracted video frames, and the at least one image is less than or equal to the predetermined number.

In some embodiments, determining the reply to the query request includes: determining, in response to a number of the at least one image not exceeding a first number, at least one of a first group of images or a first group of video frames from at least one of the first image or the extracted video frames according to a reception time, a sum of at least one of the first group of images or the first group of video frames being a second number, and a sum of the second number and the first number being less than or equal to the predetermined number; and determining, using the machine learning model, the reply to the query request based on the query request, the at least one image, and further based on at least one of the first group of images or the first group of video frames.

In some embodiments, determining the reply to the query request further includes: determining, in response to the number of the at least one image exceeding the first number, the first number of images from the at least one image based on a matching degree between the keyword information and respective keyword information corresponding to the at least one image; determining at least one of a second group of images or a second group of video frames from the at least one of the first image or the extracted video frames according to the reception time, a sum of at least one of the second group of images or the second group of video frames being a third number, and a sum of the third number and the first number being less than or equal to the predetermined number; and determining, using the machine learning model, the reply to the query request based on the query request, the first number of images, and further based on the at least one of the second group of images or the second group of video frames.

In some embodiments, the dataset is updated by: extracting, in response to receiving a second image or a second video during an interaction with the user, keyword information from the second image or video frames of the second video; and storing the extracted keyword information, the second image or the video frames of the second video, and the reception time of the second image or an extraction time of the video frames in the dataset in an association way.

In some embodiments, extracting the key information from the second image or the video frames of the second video includes: performing object recognition processing on the second image or the video frames of the second video to determine at least one object, an object identification of the at least one object being determined as at least a part of the keyword information; and/or performing text recognition processing on the second image or the video frames of the second video to determine text, the text being determined as at least a part of the keyword information.

In some embodiments, extracting the keyword information from the query request includes: extracting the keyword information from query text corresponding to the query request through keyword division processing.

The embodiments of the present disclosure further provide a corresponding apparatus for implementing the above method or process. FIG. 5 shows an exemplary structural block diagram of an apparatus 500 for question answering processing according to some embodiments of the present disclosure. The apparatus 500 may be implemented as or included in the client device 110. Each module/component in the apparatus 500 may be implemented by hardware, software, firmware, or any combination thereof.

As shown in FIG. 5, the apparatus 500 includes an information extraction module 510 configured to extract, in response to receiving a query request from a user, keyword information from the query request. The apparatus 500 further includes an image determination module 520 configured to determine, based on a match between the keyword information and keyword information corresponding to an image in a dataset associated with the user, at least one image matching the keyword information from the dataset, the dataset including images received during a historical interaction with the user and corresponding keyword information. The apparatus 500 further includes a reply determination module 530 configured to determine, using a machine learning model, a reply to the query request based at least on the query request and the at least one image.

In some embodiments, at least one of a first image or a first video is received in association with the reception of the query request, and the reply determination module 530 is further configured to: determine, using the machine learning model, the reply to the query request based on the query request, the at least one image, and also on at least one of the received first image or video frames extracted from the first video.

In some embodiments, a model input of the machine learning model is defined to include at most a predetermined number of images, and a sum of the received first image and/or the extracted video frames, and the at least one image is less than or equal to the predetermined number.

In some embodiments, the reply determination module 530 is further configured to: determine, in response to a number of the at least one image not exceeding a first number, at least one of a first group of images or a first group of video frames from the at least one of the first image or the extracted video frames according to a reception time, a sum of at least one of the first group of images or the first group of video frames being a second number, and a sum of the second number and the first number being less than or equal to the predetermined number; and determine, using the machine learning model, the reply to the query request based on the query request, the at least one image, and further based on at least one of the first group of images or the first group of video frames.

In some embodiments, the answer determination module 530 is further configured to: determine, in response to the number of the at least one image exceeding the first number the first number of images from the at least one image based on a matching degree between the keyword information and respective keyword information corresponding to the at least one image; determine at least one of a second group of images or a second group of video frames from the at least one of the first image or the extracted video frames according to the reception time, a sum of at least one of the second group of images or the second group of video frames being a third number, and a sum of the third number and the first number being less than or equal to the predetermined number; and determine, using the machine learning model, the reply to the query request based on the query request, the first number of images, and further based on the at least one of the second group of images or the second group of video frames.

In some embodiments, the dataset is updated by: extracting, in response to receiving a second image or a second video during an interaction with the user, keyword information from the second image or video frames of the second video; and storing the extracted keyword information, the second image or the video frames of the second video, and the reception time of the second image or an extraction time of the video frames in the dataset in an association way.

In some embodiments, extracting the key information from the second image or the video frames of the second video includes: performing object recognition processing on the second image or the video frames of the second video to determine at least one object, an object identification of the at least one object being determined as at least a part of the keyword information; and/or performing text recognition processing on the second image or the video frames of the second video to determine text, the text being determined as at least a part of the keyword information.

In some embodiments, the information extraction module 510 is further configured to: extract the keyword information from query text corresponding to the query request through keyword division processing.

The units and/or modules included in the apparatus 500 may be implemented in various ways, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and more.

It should be understood that one or more steps in the above methods may be performed by an appropriate electronic device or a combination of electronic devices. Such an electronic device or a combination of electronic devices may include, for example, the client device 110 and/or the server device 120 in FIG. 1.

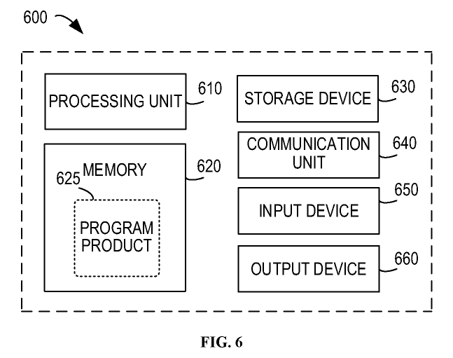

FIG. 6 shows a block diagram of an electronic device 600 in which one or more embodiments of the present disclosure may be implemented. It should be understood that the electronic device 600 shown in FIG. 6 is only illustrative and should not constitute any limitation on the functions and scope of the embodiments described herein. The electronic device 600 shown in FIG. 6 may be used to implement the client device 110 and/or the server device 120 in FIG. 1.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be a physical or virtual processor and may execute various processes based on the programs stored in the memory 620. In a multi-processor system, multiple processing units execute computer executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 implements communication with other electronic devices through the communication medium. In addition, the functions of the components of the electronic device 600 may be implemented by a single computing cluster or multiple computing machines, which may communicate through a communication connection. Therefore, the electronic device 600 may use a logical connection with one or more other servers, a network personal computer (PC) or a further network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) as needed through the communication unit 640, such as a storage device, a display device, etc., communicate with one or more devices that cause the user to interact with the electronic device 600, or communicate with any devices (such as a network card, a modem, etc.) that cause the electronic device 600 to communicate with one or more other electronic devices. Such communication may be performed via input/output (I/O) interfaces (not shown).

According to an exemplary implementation of the present disclosure, there is provided a computer-readable storage medium having computer-executable instructions stored thereon, where the computer-executable instructions are executed by a processor to implement the method described above. According to an exemplary implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described here with reference to the flowcharts and/or block diagrams of the method, the apparatus, the device, and the computer program product implemented according to the present disclosure. It should be understood that each block of the flowchart and/or block diagram and the combination of each block in the flowchart and/or block diagram may be implemented by computer-readable program instructions.

These computer-readable program instructions may be provided to the processing unit of a general-purpose computer, a dedicated computer, or other programmable data processing apparatus to produce a machine, so that when the instructions are executed by the processing unit of the computer or other programmable data processing apparatus, an apparatus that implements the functions/actions specified in one or more blocks of the flowchart and/or block diagram is produced. These computer-readable program instructions may also be stored in a computer-readable storage medium, and these instructions cause the computer, the programmable data processing apparatus, and/or other devices operate in a specific way. Thus, the computer-readable medium storing the instructions includes a manufactured product, which includes instructions for implementing various aspects of the functions/actions specified in one or more blocks of the flowchart and/or block diagram.

The computer-readable program instructions may be loaded onto a computer, other programmable data processing apparatus, or other devices, so that a series of operation steps are performed on the computer, other programmable data processing apparatus, or the other devices to produce a computer-implemented process, and thus, the instructions executed on the computer, other programmable data processing apparatus, or other devices implement the functions/actions specified in one or more blocks of the flowchart and/or block diagram.

The flowcharts and block diagrams in the drawings show the possibly implemented architectures, functions, and operations of the system, the method, and the computer program product according to multiple implementations of the present disclosure. In this regard, each block in the flowchart or block diagram may represent a module, a program segment, or a part of an instruction, which includes one or more executable instructions for implementing the specified logical functions. In some updated implementations, the functions marked in the blocks may also occur in an order different from that being marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that performs specified functions or actions, or may be implemented by a combination of dedicated hardware and computer instructions.

The implementations of the present disclosure have been described above, and the above description is exemplary, non-exhaustive, and not limited to the disclosed implementations. Many modifications and changes will be apparent to those of ordinary skill in the art without departing from the scope and spirit of the illustrated implementations. The terms used herein are chosen to best explain the principles of the implementations, the practical applications, or the improvements to the technologies in the market, or to enable other those of ordinary skill in the art to understand the implementations disclosed herein.

1. A method for question answering processing, comprising:
extracting, in response to receiving a query request from a user, keyword information from the query request;
determining, based on a match between the keyword information and keyword information corresponding to an image in a dataset associated with the user, at least one image matching the keyword information from the dataset, the dataset comprising images received during a historical interaction with the user and corresponding keyword information; and
determining, using a machine learning model, a reply to the query request based at least on the query request and the at least one image.

2. The method of claim 1, wherein at least one of a first image or a first video is received in association with the reception of the query request, and wherein determining the reply to the query request based at least on the query request and the at least one image comprises:
determining, using the machine learning model, the reply to the query request based on the query request, the at least one image, and further based on at least one of the received first image or video frames extracted from the first video.

3. The method of claim 2, wherein a model input of the machine learning model is defined to comprise at most a predetermined number of images, and wherein a sum of the received first image and/or the extracted video frames, and the at least one image is less than or equal to the predetermined number.

4. The method of claim 3, wherein determining the reply to the query request comprises:
determining, in response to a number of the at least one image not exceeding a first number, at least one of a first group of images or a first group of video frames from the at least one of the first image or the extracted video frames according to a reception time, a sum of at least one of the first group of images or the first group of video frames being a second number, and a sum of the second number and the first number being less than or equal to the predetermined number; and
determining, using the machine learning model, the reply to the query request based on the query request, the at least one image, and further based on the at least one of the first group of images or the first group of video frames.

5. The method of claim 4, wherein determining the reply to the query request further comprises:
determining, in response to the number of the at least one image exceeding the first number, the first number of images from the at least one image based on a matching degree between the keyword information and respective keyword information corresponding to the at least one image;
determining at least one of a second group of images or a second group of video frames from the at least one of the first image or the extracted video frames according to the reception time, a sum of at least one of the second group of images or the second group of video frames being a third number, and a sum of the third number and the first number being less than or equal to the predetermined number; and
determining, using the machine learning model, the reply to the query request based on the query request, the first number of images, and further based on the at least one of the second group of images or the second group of video frames.

6. The method of claim 1, wherein the dataset is updated by:
extracting, in response to receiving a second image or a second video during an interaction with the user, keyword information from the second image or video frames of the second video; and
storing the extracted keyword information, the second image or the video frames of the second video, and the reception time of the second image or an extraction time of the video frames in the dataset in an association way.

7. The method of claim 6, wherein extracting the key information from the second image or the video frames of the second video comprises:
performing object recognition processing on the second image or the video frames of the second video to determine at least one object, an object identification of the at least one object being determined as at least a part of the keyword information; and/or
performing text recognition processing on the second image or the video frames of the second video to determine text, the text being determined as at least a part of the keyword information.

8. The method of claim 1, wherein extracting the keyword information from the query request comprises:
extracting the keyword information from query text corresponding to the query request through keyword division processing.

9. An electronic device, comprising:
at least one processor; and
at least one memory, which is coupled to the at least one processor and stores instructions executable by the at least one processor, the instructions, when executed by the at least one processor, causing the electronic device to perform operations comprising:
extracting, in response to receiving a query request from a user, keyword information from the query request;
determining, based on a match between the keyword information and keyword information corresponding to an image in a dataset associated with the user, at least one image matching the keyword information from the dataset, the dataset comprising images received during a historical interaction with the user and corresponding keyword information; and
determining, using a machine learning model, a reply to the query request based at least on the query request and the at least one image.

10. The electronic device of claim 9, wherein at least one of a first image or a first video is received in association with the reception of the query request, and wherein determining the reply to the query request based at least on the query request and the at least one image comprises:
determining, using the machine learning model, the reply to the query request based on the query request, the at least one image, and further based on at least one of the received first image or video frames extracted from the first video.

11. The electronic device of claim 10, wherein a model input of the machine learning model is defined to comprise at most a predetermined number of images, and wherein a sum of the received first image and/or the extracted video frames, and the at least one image is less than or equal to the predetermined number.

12. The electronic device of claim 11, wherein determining the reply to the query request comprises:
determining, in response to a number of the at least one image not exceeding a first number, at least one of a first group of images or a first group of video frames from the at least one of the first image or the extracted video frames according to a reception time, a sum of at least one of the first group of images or the first group of video frames being a second number, and a sum of the second number and the first number being less than or equal to the predetermined number; and
determining, using the machine learning model, the reply to the query request based on the query request, the at least one image, and further based on the at least one of the first group of images or the first group of video frames.

13. The electronic device of claim 12, wherein determining the reply to the query request further comprises:
determining, in response to the number of the at least one image exceeding the first number, the first number of images from the at least one image based on a matching degree between the keyword information and respective keyword information corresponding to the at least one image;
determining at least one of a second group of images or a second group of video frames from the at least one of the first image or the extracted video frames according to the reception time, a sum of at least one of the second group of images or the second group of video frames being a third number, and a sum of the third number and the first number being less than or equal to the predetermined number; and
determining, using the machine learning model, the reply to the query request based on the query request, the first number of images, and further based on the at least one of the second group of images or the second group of video frames.

14. The electronic device of claim 9, wherein the dataset is updated by:
extracting, in response to receiving a second image or a second video during an interaction with the user, keyword information from the second image or video frames of the second video; and
storing the extracted keyword information, the second image or the video frames of the second video, and the reception time of the second image or an extraction time of the video frames in the dataset in an association way.

15. The electronic device of claim 14, wherein extracting the key information from the second image or the video frames of the second video comprises:
performing object recognition processing on the second image or the video frames of the second video to determine at least one object, an object identification of the at least one object being determined as at least a part of the keyword information; and/or
performing text recognition processing on the second image or the video frames of the second video to determine text, the text being determined as at least a part of the keyword information.

16. The electronic device of claim 9, wherein extracting the keyword information from the query request comprises:
extracting the keyword information from query text corresponding to the query request through keyword division processing.

17. A non-transitory computer-readable storage medium comprising computer-executable instructions stored thereon, the computer-executable instructions being executable by a processor to perform operations comprising:
extracting, in response to receiving a query request from a user, keyword information from the query request;
determining, based on a match between the keyword information and keyword information corresponding to an image in a dataset associated with the user, at least one image matching the keyword information from the dataset, the dataset comprising images received during a historical interaction with the user and corresponding keyword information; and
determining, using a machine learning model, a reply to the query request based at least on the query request and the at least one image.

18. The non-transitory computer-readable storage medium of claim 17, wherein at least one of a first image or a first video is received in association with the reception of the query request, and wherein determining the reply to the query request based at least on the query request and the at least one image comprises:
determining, using the machine learning model, the reply to the query request based on the query request, the at least one image, and further based on at least one of the received first image or video frames extracted from the first video.

19. The non-transitory computer-readable storage medium of claim 18, wherein a model input of the machine learning model is defined to comprise at most a predetermined number of images, and wherein a sum of the received first image and/or the extracted video frames, and the at least one image is less than or equal to the predetermined number.

20. The non-transitory computer-readable storage medium of claim 19, wherein determining the reply to the query request comprises:
determining, in response to a number of the at least one image not exceeding a first number, at least one of a first group of images or a first group of video frames from the at least one of the first image or the extracted video frames according to a reception time, a sum of at least one of the first group of images or the first group of video frames being a second number, and a sum of the second number and the first number being less than or equal to the predetermined number; and
determining, using the machine learning model, the reply to the query request based on the query request, the at least one image, and further based on the at least one of the first group of images or the first group of video frames.
